(19) United States
(12) Patent Application Publication
(10) Pub. No.: US 2025/0130332 A1
(43) Pub. Date: Apr. 24, 2025

(54) SYSTEM AND METHOD FOR CORRECTING SATELLITE OBSERVATIONS

(71) Applicant: Swift Navigation, Inc., San Francisco, CA (US)

(72) Inventors: Anthony Mark Cole, San Francisco, CA (US); Fergus MacPherson Noble, San Francisco, CA (US); James Tidd, San Francisco, CA (US); Sébastien Carcanague, San Francisco, CA (US)

(73) Assignee: Swift Navigation, Inc., San Francisco, CA (US)

(21) Appl. No.: 18/990,985

(22) Filed: Dec. 20, 2024

Related U.S. Application Data
(63) Continuation of application No. 18/514,103, filed on Nov. 20, 2023, now Pat. No. 12,216,211.
Application No. 18/514,103 is a division of application No. 18/079,640, filed on Dec. 12, 2022, now abandoned.
(60) Provisional application No. 63/288,381, filed on Dec. 10, 2021.

(51) Int. Cl. G01S 19/07; G01S 19/44

(52) U.S. Cl. CPC G01S 19/073; G01S 19/44

(57) ABSTRACT

A system or method for determining a satellite observation for a virtual reference station can include: determining a virtual reference station location, receiving a set of satellite observations at a reference station located at a reference station location, determining a first GNSS correction for the virtual reference station location and a second GNSS correction for the reference station location, and determining the satellite observation for the virtual reference station by combining the set of satellite observations, the first GNSS correction, and the second GNSS correction.

### CROSS-REFERENCE TO RELATED APPLICATIONS

This application is a continuation of U.S. patent application Ser. No. 18/514,103 filed 20 Nov. 2023, which is a divisional of U.S. patent application Ser. No. 18/079,640 filed 12 Dec. 2022 which claims the benefit of U.S. Provisional Application No. 63/288,381, filed 10 Dec. 2021, each of which is incorporated in its entirety by this reference.

### TECHNICAL FIELD

This invention relates generally to the satellite positioning field, and more specifically to a new and useful system and method in the satellite positioning field.

### BRIEF DESCRIPTION OF THE FIGURES

FIG. 1 is a schematic representation of the system.

FIG. 2 is a schematic representation of the method.

FIG. 3 is a flow diagrammatic representation of an example of the method.

FIG. 4 is a schematic representation of an example of error estimation for an RTK, a network RTK, an SSR, and an SSR with virtual reference stations systems.

FIG. 5 is a schematic representation of an example geometry for a GNSS receiver, virtual reference station, and base station.

FIG. 6 is a schematic representation of an example of setting a virtual reference station and updating a virtual reference station.

FIG. 7 is a schematic representation of an example of generating GNSS corrections (e.g., SSR corrections).

FIGS. 8A and 8B are schematic representations of examples of virtual reference stations when two or more GNSS receivers are used in a common location.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

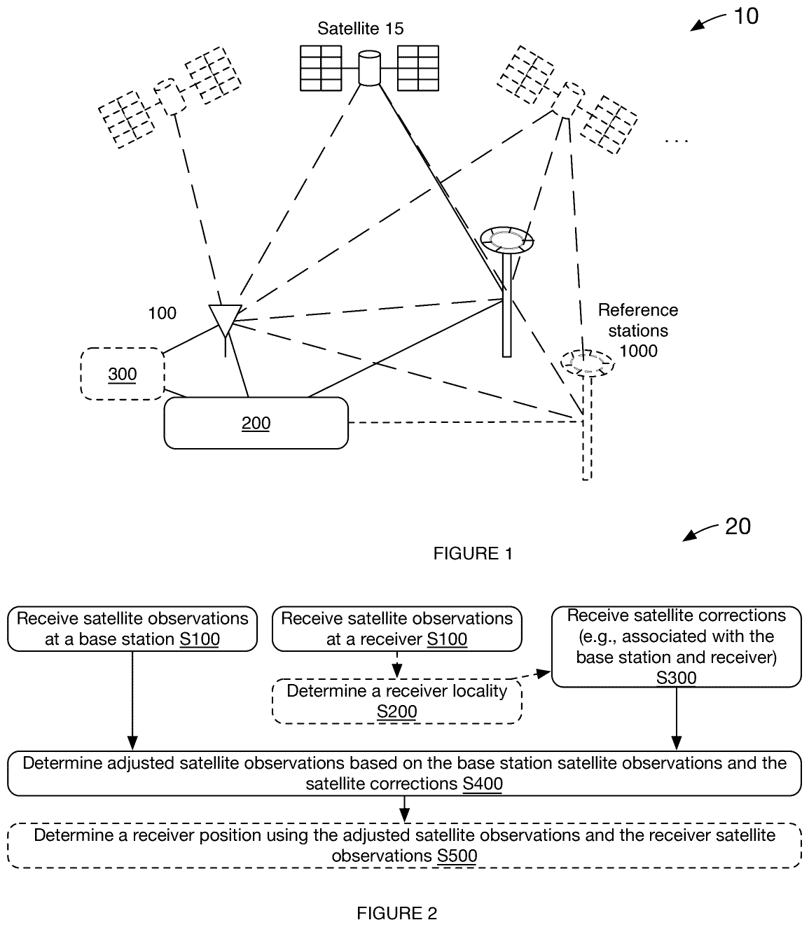

As shown in FIG. 1, the system 10 can include a GNSS receiver 100, a base station 1000 (e.g., reference station), and a computing system 200. The system can optionally include one or more data sources (e.g., satellite 15, sensor 300, etc.), an external system, and/or any suitable components.

As shown in FIG. 2, the method 20 can include receiving satellite observations S100, receiving satellite corrections S200, and determining adjusted satellite observations S300 (e.g., determining satellite observations associated with a virtual reference station). The method can optionally include: determining a GNSS receiver locality S150, determining a GNSS receiver position S400, and/or any suitable steps.

The system and/or method preferably function to determine a position of a GNSS receiver, determine corrections (e.g., to facilitate or improve GNSS positioning solution determination), and/or can otherwise function. Embodiments of the system and/or method can be used, for example, in autonomous or semi-autonomous vehicle guidance (e.g., for unmanned aerial vehicles (UAVs), unmanned aerial systems (UAS), self-driving cars, agricultural equipment, robotics, rail transport/transit systems, autonomous trucking, last mile delivery, etc.), GPS/GNSS research, surveying systems, user devices, mobile applications, internet-of-things (IOT) devices, and/or may be used in any other suitable application. In specific examples, the system (and/or components) can be coupled to any suitable external system such as a vehicle (e.g., UAV, UAS, car, truck, etc.), robot, railcar, user device (e.g., cell phone), and/or any suitable system, and can provide positioning data, integrity data (e.g., protection level data), and/or other data to said system, wherein the system can use the data for control and/or navigation.

### 2. Benefits

Variations of the technology can confer several benefits and/or advantages.

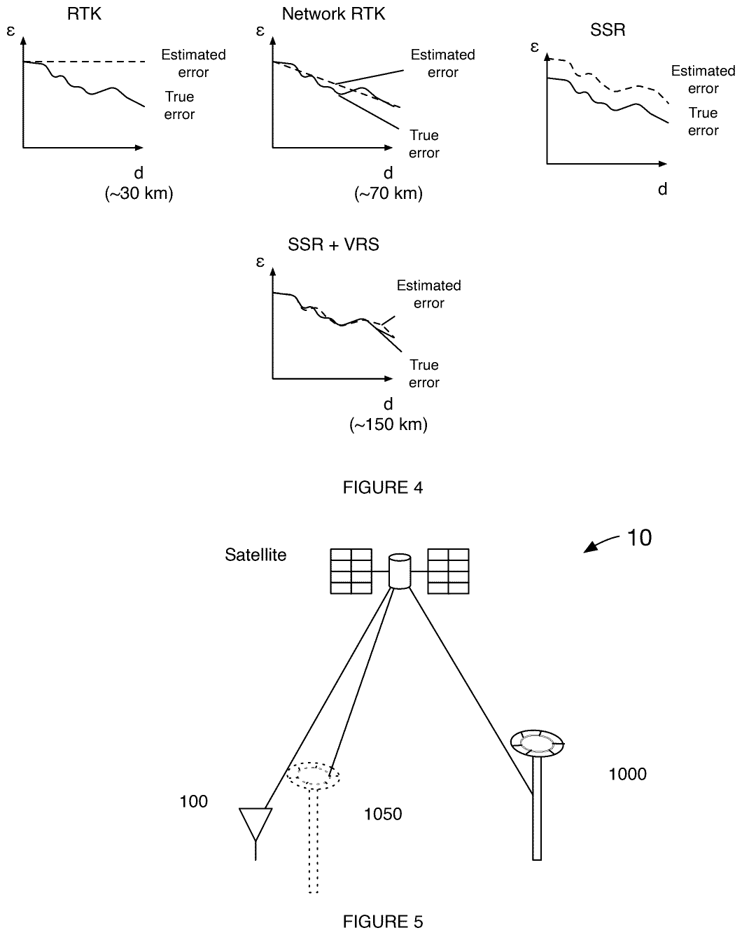

First, variants of the technology can enable high accuracy (e.g., mm-, cm-, dm-, m-, level etc. such as 1 mm, 2 mm, 5 mm, 1 cm, 2 cm, 5 cm, 1 dm, 2 dm, 5 dm, 1 m, etc.) GNSS positioning solutions to be determined at large distances from base stations. For example (as shown for instance in FIG. 4), solutions using real-time kinematic approaches can have high accuracy when the distance between the base station and the GNSS receiver is at most about 30-70 km. Examples of the technology can enable high accuracy positioning solutions to be determined when the distance between the base station and the GNSS receiver is 140-200 km (or even larger baselines as well as accommodating smaller baselines). For instance, combining SSR corrections (e.g., state space representation corrections) with OSR-type corrections (e.g., observation space representation corrections) can enable these larger baselines (e.g., where at shorter distances the positioning solutions can be improved for instance by the reference station information).

Second, variants of the technology can enable higher positioning accuracy for GNSS positioning solutions operating using SSR corrections, particularly but not exclusively near (e.g., proximal; within a threshold distance of; at most about 1 km, 5 km, 10 km, 20 km, 30 km, 50 km, 75 km, 100 km, etc. from; etc.) a base station. For instance, combining SSR corrections (e.g., state space representation corrections) with OSR-type corrections (e.g., observation space representation corrections) can enable higher accuracy solutions near a base station (e.g., approaching the accuracy of using the base station observations directly).

However, variants of the technology can confer any other suitable benefits and/or advantages.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30%, etc. of a reference), or be otherwise interpreted.

### 3. System

As shown in FIG. 1, the system 10 can include a GNSS receiver 100, a base station 1000 (also referred to as a reference station), and a computing system 200. The system can optionally include one or more data sources (e.g., satellite 15, sensor 300, etc.), an external system, and/or any suitable components. The system preferably functions to determine the position of a GNSS receiver and/or external system, determine corrections to satellite observations (e.g., detected by the GNSS receiver), and/or can otherwise function.

The system preferably uses a set of data collected by one or more data sources. Data sources can include: GNSS receivers 100, sensors 300 (e.g., located onboard the GNSS receiver, the external system, a reference station, etc.), databases, base stations 1000 (e.g., reference stations), satellites 15, and/or any other suitable data source. Examples of data that can be used include: satellite observations (e.g., satellite code, carrier phase, Doppler, etc.; derived information such as pseudorange; etc.), sensor data, and/or any other suitable data.

The GNSS receiver preferably functions to receive a set of satellite observations (e.g., satellite signals) from one or more satellites. In variants, the GNSS receiver (or a processor thereof) can determine the location (e.g., by using pseudoranges, by using carrier phase) of the GNSS receiver (e.g., the GNSS receiver antenna, the external system, etc.) based on the satellite observations. The GNSS receiver is preferably in communication with the computing system. However, the GNSS receiver can be integrated with the computing system, and/or the GNSS receiver and computing system can be arranged in any suitable manner. The GNSS receiver can be a stand-alone device (e.g., including an antenna), integrated into the external system (e.g., be a component of an automobile, aero vehicle, nautical vehicle, etc.), can be a user device (e.g., smart phone, laptop, cell phone, smart watch, etc.), and/or can be configured in any suitable manner.

A GNSS receiver 100 can be configured to receive satellite observations associated with one or more satellite constellations, one or more carrier frequencies (e.g., the L1, L2, L5, E1, E5a, E5b, Eab, E6, G1, G3, B1, B2, B3, LEX, etc. frequencies), and/or any suitable data. For example, the GNSS receiver can be a single frequency receiver (e.g., track a single satellite frequency), a multi-frequency receiver (e.g., receive and/or track satellite signals with more than one frequency, include two or more antennas, etc.), and/or any suitable receiver.

The base station(s) 1000 preferably function to receive satellite observations which can be used to correct satellite observations made at the GNSS receiver (e.g., mobile receiver). The base station satellite observations can be used to difference (e.g., form combinations with) the GNSS receiver observations, to model corrections (e.g., used by a corrections generator to generate a model of the GNSS corrections), and/or can otherwise be used. The base stations are typically within a threshold distance of the GNSS receiver (e.g., within 10 km, 20 km, 50 km, 100 km, 150 km, 300 km, etc.), but can be further than the threshold distance from the GNSS receiver. The base stations are preferably distributed such that for a given geographical region (e.g., city, county, province, state, country, continent, etc.) a GNSS receiver is within the threshold distance of at least one base station. However, the base stations can otherwise be distributed or arranged (e.g., based on a probability of a GNSS receiver being within a given spatial area, based on a frequency of GNSS receivers in a given region, etc.). The base stations are preferably at substantially the same height relative to sea level (e.g., within about 100 m of the same height above sea level), but can have any suitable height(s) relative to each other and/or relative to the sea level.

The set of satellite observations (e.g., measured by the GNSS receiver, measured by the base station, etc.) can include orbital data, timestamp, range rate data, carrier phase data, pseudorange data, doppler data, and/or any suitable data. The set of satellite observations can be associated with metadata (e.g., ephemeris), and/or any suitable data. The set of satellite observations preferably includes satellite observations corresponding to satellites from more than one satellite constellation (e.g., Global Positioning System (GPS), GLObal Navigation Satellite System (GLONASS), BeiDou positioning System (BDS), Galileo, Navigation with Indian Constellation (NavIC), Quasi-Zenith Satellite System (QZSS), GPS Aided Geo Augmented Navigation (GAGAN), etc.). However, the set of satellite observations can correspond to satellites from a single satellite constellation, can include data from an augmentation system (e.g., Satellite Based Augmentation System (SBAS) such as Wide Area Augmentation System (WAAS), European Geostationary Navigation Overlay Service (EGNOS), Multi-Functional Satellite Augmentation System (MSAS), Omnistar, StarFire, etc.; Ground Based Augmentation Systems (GBAS) such as Local Area Augmentation System (LAAS); etc.), and/or can include any suitable data. Each satellite observation from the set of satellite observations preferably corresponds to a common time window (e.g., epoch). However, each satellite observation can be associated with a timestamp (e.g., time of transmission, time of receipt, time of processing, etc.), and/or the satellite observations can have any suitable timing.

The optional sensor(s) 300 can function to measure sensor data (e.g., auxiliary data) associated with the external system (and/or the GNSS receiver). The sensor data can be used to determine (e.g., independent of the satellite observations) the external system location (e.g., fused with the GNSS positioning solution or satellite signals such as disclosed in U.S. patent application Ser. No. 17/860,779 titled ‘SYSTEM AND METHOD FOR FUSING DEAD RECKONING AND GNSS DATA STREAMS’ filed 8 Jul. 2022 which is incorporated in its entirety by this reference), but can additionally or alternatively be used to assist (e.g., speed-up, correct, refine, etc.) the calculation (e.g., calculating the state vector, estimating the phase ambiguity, converge or reconverge such as disclosed for example in U.S. patent application Ser. No. 17/686,588 titled ‘SYSTEM AND METHOD FOR RECONVERGING GNSS POSITION ESTIMATES’ filed 4 Mar. 2022 which is incorporated in its entirety by this reference, etc.) of position from the satellite observations and/or be otherwise used. The sensors are preferably in communication with the computing system.

The sensors can be: on-board the external system, on-board a separate external system, integrated into the GNSS receiver, separate from the GNSS receiver, and/or otherwise associated with the GNSS receiver.

The sensor data can include: inertial data (e.g., acceleration, angular velocity, angular acceleration, magnetic field, etc.), odometry, pose (e.g., position, orientation), mapping data (e.g., images, point clouds), temperature, pressure, ambient light, images (e.g., thermal images, optical images, etc.; landmarks, features, etc. associated with the images; etc.), video feeds, and/or any other suitable data. The sensors can include one or more of: inertial measurement unit (IMU), accelerometer, gyroscope, magnetometer, odometer (e.g., wheel speeds; wheel ticks; steering angles; visual odometers such as cameras; etc.), pressure sensors, distance measurement instrument, image sensor (e.g., camera, thermal camera, etc.), LIDAR, RADAR, SONAR, and/or any suitable sensor.

The system (e.g., an external system connected to the system, a base station, etc.) can include more than one GNSS receivers and/or sensors, which can function to provide redundancy, provide information in the event of an outage to one of the GNSS receivers or sensors, provide validation and/or cross checks between data sources (e.g., be used to monitor or detect the incoming data streams), and/or otherwise function. The relative pose between each GNSS receiver (e.g., between each GNSS receiver antenna), each sensor, and/or each GNSS receiver/sensor pair is preferably known, but can be unknown.

The computing system 200 preferably functions to process the data (e.g., satellite observations, base station observations, sensor data, etc.) received by the GNSS receiver(s), the base station(s), and/or the sensor(s). The computing system can: aggregate the data (e.g., combine the GNSS receiver satellite observations, base station satellite observations, satellite corrections, and/or sensor data; reorganize the GNSS receiver satellite observations, base station satellite observations, and/or sensor data such as based on the timestamp, time of transmission, time of receipt, etc.; etc.), filter the data (e.g., to calculate state vectors, ambiguities such as phase ambiguities, etc. associated with the data), calculate the GNSS receiver position (e.g., the GNSS phase center position), calculate an integrity of the solution (e.g., the protection level, the integrity risk, the total integrity risk, etc.), calculate the external system location, correct the data (e.g., correct the satellite observations for clock errors, hardware bias, atmospheric effects, etc.), and/or can process the data in any suitable manner. The computing system can be local (e.g., to the external system, to the GNSS receiver, to a base station, etc.), remote (e.g., cloud computing, server, networked, etc.), and/or otherwise distributed.

The computing system is preferably communicably coupled to the GNSS receiver and/or the base station(s), but can be communicably coupled to any suitable data sources. The computing system is preferably distributed between a local computing system that is colocalized with (e.g., integrated into) the GNSS receiver (and/or external system) and a remote computing system (e.g., a cloud computing server, remote computer bank, etc.). However, the computing system can be a remote computing system, a local computing system (e.g., collocated with the GNSS receiver, integrated in the external system, etc.), and/or can otherwise be distributed (e.g., between two or more separate servers).

The computing system can include (and/or be connected to) a corrections generator (e.g., a corrections service, corrections modelling engine, reliability engine, etc.), a monitor (e.g., corrections monitor, satellite signal monitor, metadata monitor, etc.), a VRS generator, and/or any suitable components.

The corrections generator functions to determine (e.g., model, filter, calculate, compute, estimate, etc.) the GNSS corrections. The corrections generator can generate corrections from reference station data (e.g., pseudorange and/or carrier phase from reference stations), global corrections data (e.g., satellite clock, satellite orbit, bias, etc.), and/or metadata (e.g., reference station positions, ocean tide loading, antenna type, receiver type, etc.), but may additionally or alternatively generate corrections using sensor data, satellite observations (e.g., as detected at a GNSS receiver), and/or any input data.

The GNSS corrections are preferably SSR (state space representation) corrections (e.g., error estimates separate error source(s)). However, the GNSS corrections can additionally or alternatively include be OSR (observation space representation) corrections (e.g., a lump sum of errors resulting from one or more error source such as satellite clock, satellite orbit, satellite signal bias, ionospheric delay, ionospheric advance, tropospheric delay, etc. such as provided as a range correction for a combination of satellites, frequencies, and/or signals), and/or can be any suitable correction representation.

The monitor can function to detect (and/or mitigate) one or more predetermined events in input data. In some variants, the monitor can additionally or alternatively determine an accuracy and/or integrity of the GNSS corrections (e.g., an accuracy or integrity that is achievable by a positioning engine ingesting the GNSS corrections). A monitor can, for instance, determine a residual (e.g., for one or more withheld data sources), monitor outliers in a data stream (e.g., using a hybrid, variance threshold technique, a scaled variance technique, etc. as disclosed in U.S. patent application Ser. No. 16/748,517 titled ‘SYSTEMS AND METHODS FOR REDUCED-OUTLIER SATELLITE POSITIONING’ filed 21 Jan. 2020 which is incorporated in its entirety by this reference), and/or can otherwise monitor any suitable data in any suitable manner.

For example, the corrections generator and/or monitor can operate in a manner similar to a corrections engine (and/or components thereof such as PPP filters, atmospheric modeler, correction generator, reference observation monitor, correction data monitor, metadata monitor, modeling engine, reliability engine, etc.) as disclosed in U.S. patent application Ser. No. 17/829,019 titled ‘SYSTEMS AND METHODS FOR HIGH-INTEGRITY SATELLITE POSITIONING’ filed 31 May 2022 which is incorporated in its entirety by this reference. In another (related and/or combinable with the preceding example) example, a corrections generator can generate corrections (e.g., SSR corrections) using a Gaussian model (for instance in a manner as disclosed in U.S. patent application Ser. No. 17/554,397 titled ‘SYSTEM AND METHOD FOR GAUSSIAN PROCESS ENHANCED GNSS CORRECTIONS GENERATION’ filed 17 Dec. 2021 which in incorporated in its entirety by this reference) to process reference station satellite observations to estimate the corrections.

The VRS generator can function to determine a virtual reference station (VRS) location and/or to determine an observation at the VRS location (e.g., an observation, range, etc. such as would be observed by a reference station, base station, GNSS receiver, etc. at the VRS location).

The VRS location is preferably determined based on a GNSS receiver locality (e.g., received from a GNSS receiver). For instance, the VRS location can be set to a nearest grid point (e.g., grid point as disclosed in U.S. patent application Ser. No. 17/833,560 titled ‘SYSTEM AND METHOD FOR DETERMINING GNSS POSITIONING CORRECTIONS’ filed 6 Jun. 2022 which is incorporated in its entirety by this reference), nearest feature, to the approximate location of the GNSS receiver (e.g., mean position, computed locality regardless of exact position, etc.), to a predetermined VRS position located within a threshold distance of the GNSS receiver (e.g., where a grid of VRS positions can exist that cover a geographic area such that any GNSS receiver within the geographic area is at most a threshold distance from a VRS position), and/or can be determined in any manner.

The VRS location 1050 is preferably at most a threshold distance from the GNSS receiver position (and/or locality). The threshold distance is preferably at most about 10 km (e.g., 0.5 km, 1 km, 2 km, 5 km, 7 km, 10 km, 10.5 km, values or ranges therebetween). However, the threshold distance can additionally or alternatively be greater than 10 km (e.g., 15 km, 20 km, 25 km, 50 km, 100 km, etc.). The threshold distance can be fixed (e.g., constant) and/or variable (e.g., depending on a target positioning accuracy, depending on potential error sources, depending on a multipath environment proximal the GNSS receiver, depending on a multipath environment proximal the VRS position, etc.).

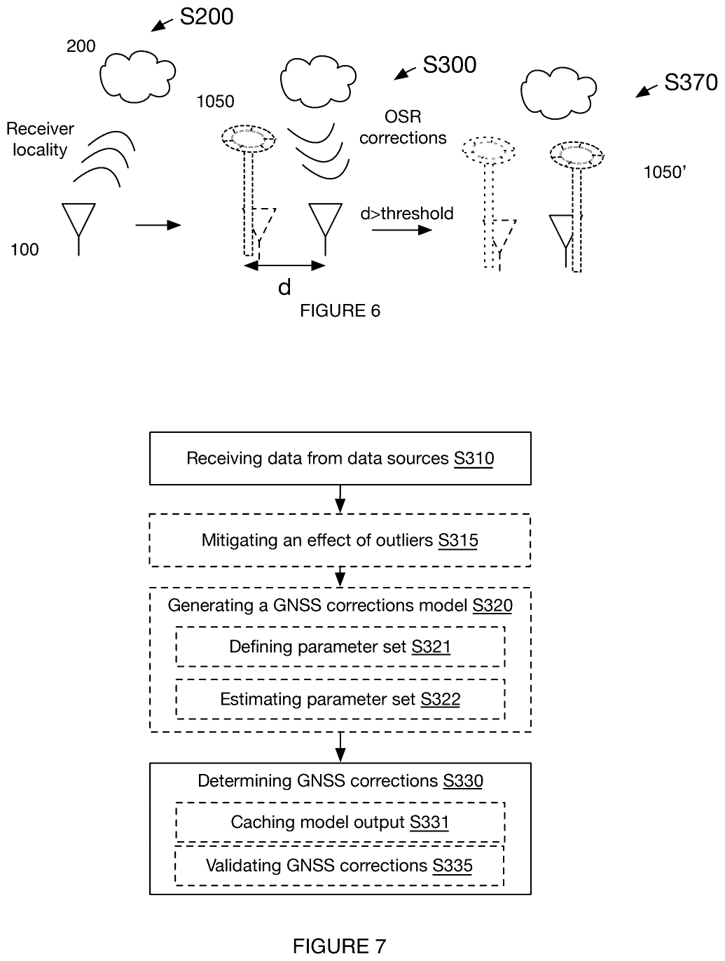

When the threshold distance is exceeded, the VRS generator can update the VRS location (e.g., determine a new VRS location 1050′, as shown for example in FIG. 6), the VRS observation can be flagged (e.g., as invalid, as below a target accuracy, as below a target integrity, etc.), and/or the VRS generator can otherwise response. The VRS location can be updated in the same and/or a different manner from the VRS location generation. As an illustrative example, when the VRS location exceeds a threshold distance, an updated VRS location can be the GNSS receiver (and/or external system) position (and/or locality) when the threshold distance is exceeded. In some variants of this illustrative example, the VRS location can be updated when the GNSS receiver position is near the threshold distance (e.g., a new VRS location can be determined when the GNSS receiver is about 1 km, 500 m, 250 m, 100 m, 50 m, 10 m, etc. of the threshold distance which can be beneficial to avoid needing to reset a server or calculation or operate during a period of time without a valid VRS observation).

The VRS generator preferably determines the VRS observation by combining the GNSS corrections (e.g., generated by the corrections generator) with reference station observations (e.g., satellite observations measured, tracked, received, etc. at one or more reference stations proximal the VRS location). However, the VRS observation can otherwise be generated.

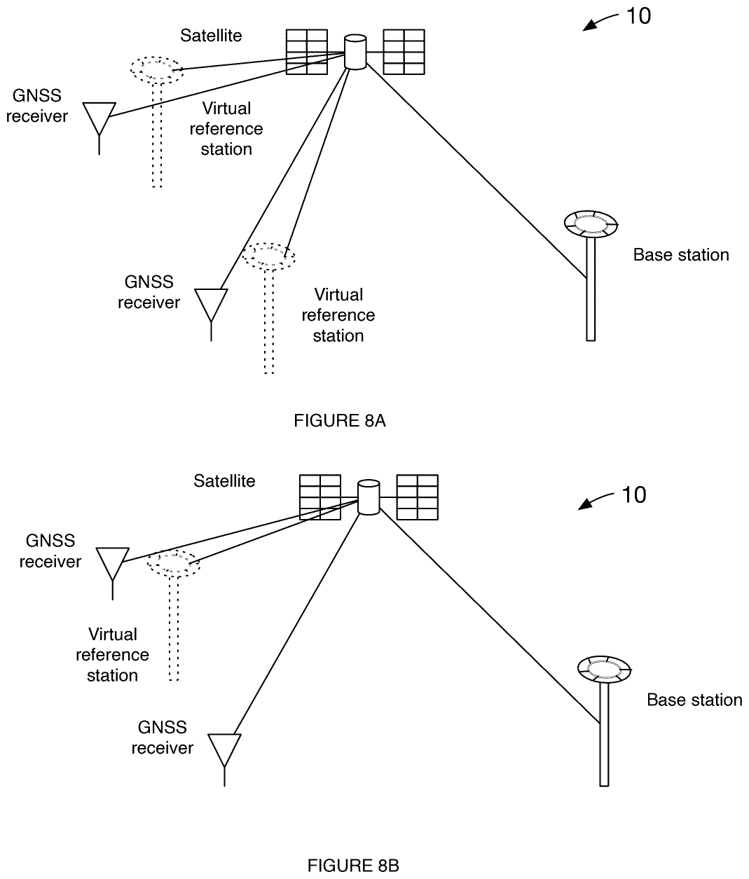

A VRS (e.g., VRS location) can be associated with (e.g., used by) a single GNSS receiver (as shown for example in FIG. 8A), a plurality of GNSS receivers (as shown for example in FIG. 8B), and/or in any suitable manner. In some variants, a plurality of VRSs can be used by one or more GNSS receivers (e.g., in a manner analogous to network RTK-corrections generations using the plurality of VRS to generate a secondary VRS).

### 4. Method

The method 20 preferably functions to determine (e.g., select, route, etc.) virtual reference station observations (which can be used as GNSS corrections to correct satellite signals or observations received by a GNSS receiver), transmit VRS observations (e.g., to a GNSS receiver, positioning engine, etc. to be used as a GNSS correction), and/or estimate (e.g., calculate, determine) a receiver position (e.g., by leveraging or using the GNSS corrections). Steps and/or substeps of the method can be performed iteratively (e.g., for different epochs, for the same epoch, etc.), sequentially, and/or in any suitable order. The steps and/or substeps of the method can be performed in series and/or in parallel. The steps and/or substeps are preferably performed by a system as described above, but can be performed by any system.

Receiving the satellite observations S100 functions to measure and/or detect a set of satellite signals, where each satellite signal is associated with a satellite. The satellite observations can be received at a base station, a GNSS receiver, a computing system (e.g., where satellite observations can be stored and/or retrieved from a database), and/or at any suitable endpoint. In a preferred embodiment, satellite signals associated with (e.g., from) a first set of satellites are received by a GNSS receiver and satellite signals associated with (e.g., from) a second set of satellites are received by a base station. The first and the second set of satellites can be the same, the first set of satellites can be a strict subset of the second set of satellites, the second set of satellites can be a strict subset of the first set of satellites, the first set of satellites can include one or more satellites that are in second set of satellites and one or more satellites that are not in the second set of satellites, and/or the first and second set of satellites can include any suitable satellites and/or relationships between satellites. Satellite signals are preferably received for a common epoch, but can be received for any suitable epoch or relative time.

Determining the receiver locality S200 preferably functions to determine an approximate receiver location. The receiver locality is preferably within about 100 km (e.g., within or less than 1 m, 5 m, 10 m, 50 m, 100 m, 500 m, 1 km, 10 km, 100 km, etc.) of the actual receiver position, but can be greater than 100 km from the actual receiver position. The receiver locality can be: coordinates, a tile identifier, a grid point identifier (and/or nearest grid point), a cell site (and/or other information transfer site), or other identifier. The receiver locality can be determined by the GNSS receiver, a computing system (e.g., a local computing system, a remote computing system, etc.), and/or by any component. Determining the receiver locality can additionally or alternatively include determining the receiver kinematics (such as receiver velocity, receiver attitude, etc.) where the receiver kinematics can be used in addition to or alternatively to the receiver locality and/or any suitable steps.

The receiver locality can be determined from (or based on) a nearest cellular tower, cellular tower trilateration, a WIFI signal, the last known receiver position (e.g., a stored receiver position, a receiver position prior to an outage, etc.), a satellite connection (e.g., satellite network), computer vision (e.g., to identify objects, features, etc. in the environment of the receiver), user input, base station signal (e.g., a nearest base station), a transponder signal, a previous receiver position (e.g., determined from a previous iteration of the method, receiver position calculated from the satellite observations without convergence, receiver position calculated from the satellite observations without validation, receiver position calculated from the satellite observations such as using pseudorange to calculate an approximate receiver location, receiver position determined prior to an outage, receiver position determined without integer fixing a carrier phase ambiguity, receiver position determined using satellite signals without correction, etc.), receiver position estimated based on or using inertial navigation (e.g., dead reckoning), receiver position estimated based on or using pilotage, receiver position estimated based on or using celestial navigation, receiver position estimated based on or using radio navigation (e.g., LORAN-C, Omega, Tacan, US Army Position Location and Reporting System, etc.), and/or can be otherwise determined.

In some embodiments, the receiver locality can be used to determine a virtual reference station (VRS) position. For instance, the VRS position can be coincident with the receiver locality (e.g., the same as; within a threshold distance such as 1 m, 5 m, 10 m, 20 m, 50 m, 100 m, 200 m, 500 m, etc. of; at a centroid of an estimated receiver locality; etc.). However, the VRS position can additionally or alternatively be determined based on nearby reference stations (e.g., be at a centroid between nearby reference stations, be at a centroid of a polygon generated by lines forming pairwise connections of base stations, etc.), be a position that depends on a plurality of GNSS receivers (e.g., a position that is within a threshold distance of a threshold number of GNSS receivers, a position determined for another GNSS receiver, etc.), be a previously determined VRS position (e.g., determined for a different GNSS receiver, determined at an earlier time, etc.), derived from the GNSS receiver locality (e.g., combine an estimated GNSS receiver locality and an estimated GNSS receiver velocity, trip plan, etc. such as to predict a direction of travel for the GNSS receiver and place the VRS position along or offset in the predicted direction of travel, a GNSS receiver path, etc.), be associated with a corrections tile (e.g., for tiled GNSS corrections, a tile center, a tile corner, etc.), and/or can be any suitable position. For example, as shown for instance in FIG. 5, the VRS position can be proximal (e.g., within about 1 km, 5 km, 10 km, 20 km, 50 km, 70 km, etc.) a GNSS receiver. However, the VRS position can be determined independent of the receiver locality (e.g., determined or set based on a geographic region that the GNSS receiver operates in, determined based on base stations or reference stations proximal the GNSS receiver, etc.) and/or otherwise be determined.

Receiving GNSS corrections S300 preferably functions to determine (e.g., look-up, access from database, access from a model, receive from a corrections generator, etc.) GNSS corrections for the GNSS receiver and/or the base station, but can determine any suitable GNSS corrections. The GNSS corrections are preferably received from a corrections generator (e.g., corrections modeler, global corrections modeler, local corrections modeler, database of corrections, corrections buffer, etc.), but can be received from any suitable source. The GNSS corrections can be associated with a spatial location (e.g., elevation, latitude, longitude, etc.), time, satellite, satellite constellation, error type, GNSS receiver (e.g., antenna), be general corrections, and/or be associated with any suitable information or data. In a specific example, GNSS corrections for a GNSS receiver are preferably determined based on the receive locality (and/or receiver position) can include any suitable errors. In a variation on this specific example, the GNSS corrections associated with a GNSS receiver can be associated with a base station and/or VRS proximal the GNSS receiver. Similarly, GNSS corrections for a base station can be determined based the base station location (e.g., a tile associated with the base station location). However, the GNSS corrections can otherwise be determined or selected.

The GNSS corrections can refer to SSR corrections, OSR corrections, and/or any suitable corrections. The GNSS corrections can include corrections for atmospheric effects (e.g., total electron count, vertical electron count, ionosphere delays or advances, troposphere delays, etc.), clock errors, orbit errors, hardware bias (e.g., GNSS receiver bias, satellite bias, etc.), multipath, cycle slip, ocean tide loading, antenna offsets, pole tides, and/or for any suitable error sources or faults. The GNSS corrections can be determined using a Gaussian model, a Kalman filter (e.g., Monte Carlo simulation), an extended Kalman filter, an unscented Kalman filter, a particle filter, and/or using nay suitable filter or algorithm. In specific examples, the SSR corrections can be generated and/or determined as disclosed in U.S. patent application Ser. No. 17/347,874 filed 15 Jun. 2021 entitled “SYSTEMS AND METHODS FOR DISTRIBUTED DENSE NETWORK PROCESSING OF SATELLITE POSITIONING DATA” or U.S. patent application Ser. No. 17/554,397 filed 17 Dec. 2021 entitled “SYSTEM AND METHOD FOR GAUSSIAN PROCESS ENHANCED GNSS CORRECTIONS GENERATION” each of which is incorporated herein in its entirety, and/or in any suitable manner.

In a specific example, the GNSS corrections (e.g., SSR corrections) can be determined (e.g., accessed, transmitted, selected, etc.) as disclosed in US Patent application Ser. No. 17/374,523 filed 13 Jul. 2021 entitled “SYSTEM AND METHOD FOR DETERMINING GNSS POSITIONING CORRECTIONS,” U.S. patent application Ser. No. 17/379,271 filed 17-JUL-2021 entitled “SYSTEM AND METHOD FOR PROVIDING GNSS CORRECTIONS” each of which is incorporated herein in its entirety, and/or in any suitable manner.

As shown for example in FIG. 7, generating GNSS corrections S300 (e.g., SSR corrections) can include: receiving data S310 (e.g., satellite signals, satellite observations associated with one or more reference station), mitigating an effect of outliers in the data S315 (e.g., using an outlier detection or mitigation technique as described in S100), determining a GNSS corrections model S320 (e.g., a Gaussian model, physical models, Kalman filter, extended Kalman filter, etc.), determining parameters of the model S321 (exemplary parameters can include covariance function(s); a functional relationship between variables such as a distance function, a time function, etc.; mapping functions; pierce points; data inputs; atmospheric shells such as shell thickness; number of shells; type of shell; etc.; hyperparameters; spatio-temporal scales such as spatial, temporal, etc. length scales; etc.), estimating parameters S322 (e.g., from previous model iterations, based on a set of training data, based on a set of tuning data, etc.), determining GNSS corrections S330 (e.g., evaluating the data using the model), caching the model output S331 (e.g., storing the GNSS corrections), validating the GNSS corrections S335 (e.g., by calculating a residual for one or more reference station observations corrected with the GNSS corrections and validating the GNSS corrections based on a threshold test, a statistical test such as a Student t-test, Bayesian testing, etc.), and/or any suitable steps.

Determining adjusted satellite observations S400 functions to determine synthetic satellite observations (e.g., adjusted GNSS corrections, adjusted satellite observations, VRS observations, etc.) which can be used for determining a PVT solution. The adjusted satellite observations can be associated with a VRS, a base station (e.g., a reference station), a GNSS receiver, and/or any suitable source. For example, adjusted satellite observations can refer to a satellite observation that would be predicted to be observed at a VRS position (e.g., satellite observations that would be observed at a location if a base station were at said position and observing satellite observations). However, adjust satellite observations can refer to any suitable data. The VRS observations are preferably determined by a remote computing system (e.g., and transmitted to the local computing system), but can be determined by the local computing system and/or by any suitable component.

The adjusted satellite observations can be determined based on (e.g., depend on) the GNSS receiver satellite observations, base station satellite observations, GNSS receiver corrections (e.g., SSR corrections predicted for a receiver, for a receiver tile, for a receiver locality, etc.), VRS receiver corrections (e.g., SSR corrections predicted for a VRS, for a VRS tile, for a VRS locality, etc.), base station receiver corrections (e.g., SSR corrections predicted for a base station, for a base station tile, for a base station locality, etc.), absolute corrections (e.g., reference information provided by a manufacturer, satellite operator, third party service, etc.), modelling, weather patterns, and/or any suitable information.

The adjusted satellite observations can be provided on a per satellite, per frequency, per epoch, per satellite constellation, per base station, per base station cluster, and/or on any suitable basis.

In a first specific example, an adjusted satellite pseudorange can be determined based on an RTK solution (e.g., a single base station) such as according to:

ρ_{VRS}=ρ_{Base}×Δ_{SSR}=ρ_{Base}+(ρ_{VRS}^{SSR}−ρ_{base}^{SSR})

Where ρ_{VRS} can be the pseudorange estimated (e.g., calculated, predicted) for the VRS, ρ_{Base} can be the pseudorange measured by a base station, ρ_{VRS}^{SSR} can be the pseudorange (or correction terms) predicted for the VRS location (e.g., the initial GNSS receiver position), and ρ_{base}^{SSR} can be the pseudorange (or correction terms) predicted for the base station.

In a variation of this specific example, the adjusted satellite observations can be determined according to:

ρ_{VRS}=ρ_{VRS}^{SSR}−Δ_{Base}=ρ_{VRS}^{SSR}−(ρ_{base}^{SSR}−ρ_{Base}).

These variations can have different physical interpretations (e.g., a VRS satellite observation is a base station observation corrected based on a difference in SSR between a base station and GNSS receiver, a VRS satellite observation is a GNSS receiver SSR correction that is adjusted based on a difference between a measured base station satellite observation and an SSR correction, etc.). The different physical interpretations can lead to different scalability, efficiency of corrections transfer to a plurality of GNSS receivers, speed of generation, number of corrections or adjust satellite observations to compute, and/or can led to any suitable differences. However, the different physical interpretations can have substantially the same efficiencies or results.

In a second variation of this specific example, an adjusted satellite observation can be determined using a network-RTK solution (e.g., based on two or more base stations). In the second variation, higher order terms (e.g., slope) can be corrected for based on the differences between a plurality of bases. In a first instance of the second variation, the adjust satellite observations can be given by ρ_{VRS}=ρ_{VRS}^{SSR}−Δ_{Base,1}−Δ_{Base,2}=ρ_{VRS}^{SSR}−(ρ_{base,1}^{SSR}−ρ_{Base,1})−(ρ_{base,2}^{SSR}−ρ_{Base,2}), where base 1 and base 2 can refer to a first and a second reference station respectively. In a second instance, the adjusted satellite observations can be given by ρ_{receiver}^{correction}=ρ_{receiver}^{SSR}−Δ_{VRS}=ρ_{receiver}^{SSR}−(ρ_{VRS}^{SSR}−ρ_{VRS}), where in the second instance, ρ_{VRS} refers to a pseudorange for a VRS determined using network RTK methods and ρ_{VRS}^{SSR} can refer to an SSR predicted pseudorange for a hypothetical base station coincident with the VRS position. However, network-RTK solutions can otherwise be integrated with this technique.

Related variations can be used to determine adjusted carrier phase observations (e.g., including a carrier phase ambiguity, a carrier phase ambiguity between locations, a carrier phase corresponding to distances between locations, etc.), adjusted doppler observations, and/or any suitable satellite signals. For instance, pseudorange can be replaced with carrier phase in the above illustrative equations (e.g., because carrier phase ambiguities can account for, accommodate, etc. residual error). In these variations, the carrier phase ambiguity can be levelled (e.g., by solving for the double difference carrier phase ambiguities between stations or using another method) such that the carrier phase ambiguities from different stations can be corrected to about the same value. Levelling the carrier phase ambiguity can provide a technical advantage of allowing carrier phases to be combined from multiple stations (e.g., as discussed above) and/or for the carrier phase corrections to be consistent when the user switches between nearest base stations.

However, the adjusted satellite observations can otherwise be determined.

Determining adjusted satellite observations can include receiving spatially variant (e.g., atmospheric) corrections S350 (e.g., at a GNSS receiver, directly from a modeler such as an atmospheric corrections modeler, from S300, etc.), which can be beneficial for not generating synthetic observations (e.g., in these variation, a VRS location and/or VRS observations may not need to be generated), enhancing (e.g., facilitating, enabling, etc.) satellite constellation support (e.g., integrating with Glonass), and/or can otherwise be beneficial. For example, the corrected reference station observation correction can be determined according to: P_{base}^{corrected}=P_{base}−A_{base}+Aᵣₒᵥₑᵣ, where P_{base}^{corrected} can be the adjusted (e.g., corrected) satellite observations (e.g., at a reference station, at a virtual reference station), P_{base} can be the measured satellite observations, A_{base} can be the atmospheric corrections (e.g., ionosphere delay or advance, troposphere delay, other spatially variant terms, etc. such as estimated by an atmospheric modeler) at the base station, and Aᵣₒᵥₑᵣ can be the atmospheric corrections for the GNSS receiver. This example can be beneficial as it may not require synthetic observation generation (e.g., for a virtual reference station). However, any suitable corrections can be received and/or the satellite observations can be corrected in any manner.

In some variants, determining adjusted satellite observations can include updating (e.g., modifying, redetermining, etc.) a VRS position S370. These variants can be particularly beneficial as a GNSS receiver moves (e.g., to ensure that a distance between the GNSS receiver and the VRS does not exceed a threshold distance such as 0.1 km, 0.2 km, 0.5 km, 1 km, 2 km, 5 km, 10 km, 20 km, 50 km, 100 km, 120 km, 150 km, 200 km, values or ranges therebetween, etc.). Updating the VRS can be performed when the GNSS receiver has moved a threshold distance, when a distance between the VRS and the GNSS receiver exceeds a threshold distance, after a threshold time has elapsed (e.g., threshold number of epochs), at a predetermined frequency, when a model updates, randomly, and/or in response to any suitable criteria and/or with any timing. When the VRS position is updated, the VRS observations are preferably also updated (e.g., determined for the updated VRS position).

Updating the VRS position preferably does not, but in some situations can, result in an outage in a PVT solution and/or a decrease in the PVT solution accuracy. In specific examples, this can be realized using a graceful handoff technique (e.g., gradually shifting a weighting on carrier phase ambiguities between a prior VRS position or observation and an updated VRS position or observations), including an arbitrary ambiguity (e.g., that accounts for differences between a prior VRS position and an updated VRS position), by modifying a base station ambiguity (e.g., with a fixed VRS position), fixing a set of VRS positions (e.g., where updating the VRS position can include selecting a new VRS position, where each VRS position has a mutually consistent solution, where VRS solutions are smoothed, etc.), by including a between base station ambiguity, moving the VRS position gradually (e.g., to maintain the threshold distance without a discontinuous shift in VRS position), and/or can otherwise be realized.

Determining the receiver PVT solution S500 preferably functions to determine (e.g., estimate, calculate, etc.) a position, velocity, and/or precise time of the GNSS receiver. The PVT solution (e.g., positioning solution) is preferably determined using corrected satellite observations, but can be determined using uncorrected satellite observations. The corrected satellite observations are preferably determined using (e.g., based on) the adjusted satellite observations (e.g., VRS satellite observations), but can be determined using the SSR corrections, the base station observations, and/or any suitable information. The corrected satellite observations can refer to differenced satellite observations (e.g., single differenced, double differenced, triple differenced, etc.), combined satellite observations (e.g., wide-lane combination, ultrawide-lane combinations, narrow lane combinations, Melbourne-Wübbena combinations, Ionosphere-free combination, Geometry-free combination, wide-lane combinations, narrow-lane combinations, Group and Phase Ionospheric Calibration (GRAPHIC) combination, combinations using carrier phase and/or code measurements, Hatch-Melbourne-Wubbena, geometry-free and ionosphere-free combinations, etc.), undifferenced satellite observations (e.g., adjusted satellite observations for a receiver locality), and/or to any suitable satellite observations. As an illustrative example, the satellite observations used to determine the GNSS receiver PVT solution can be the satellite observations received by the GNSS receiver differenced with the VRS satellite observations. However, any suitable satellite observations can be used to determine the GNSS receiver position.

The PVT solution is preferably determined using carrier phase (e.g., ambiguity resolved carrier phase), but can additionally or alternatively be determined using pseudorange, doppler, and/or any suitable satellite signal(s). Determining the PVT solution can include determining the carrier phase ambiguity (e.g., to a floating point precision, to integer precision, etc. such as disclosed in U.S. patent application Ser. No. 16/817,196 filed 12 Mar. 2020 entitled “SYSTEMS AND METHODS FOR REAL TIME KINEMATIC SATELLITE POSITIONING” or in U.S. patent application Ser. No. 17/022,924 filed 16 Sep. 2020 entitled “SYSTEMS AND METHODS FOR HIGH-INTEGRITY SATELLITE POSITIONING” each of which is incorporated in its entirety herein), determining a set of floating phase ambiguity hypotheses, determining a set of integer phase ambiguity hypotheses from the set of floating phase ambiguity hypotheses, performing hypothesis testing to validate the set of integer phase ambiguities hypotheses, and/or any suitable steps.

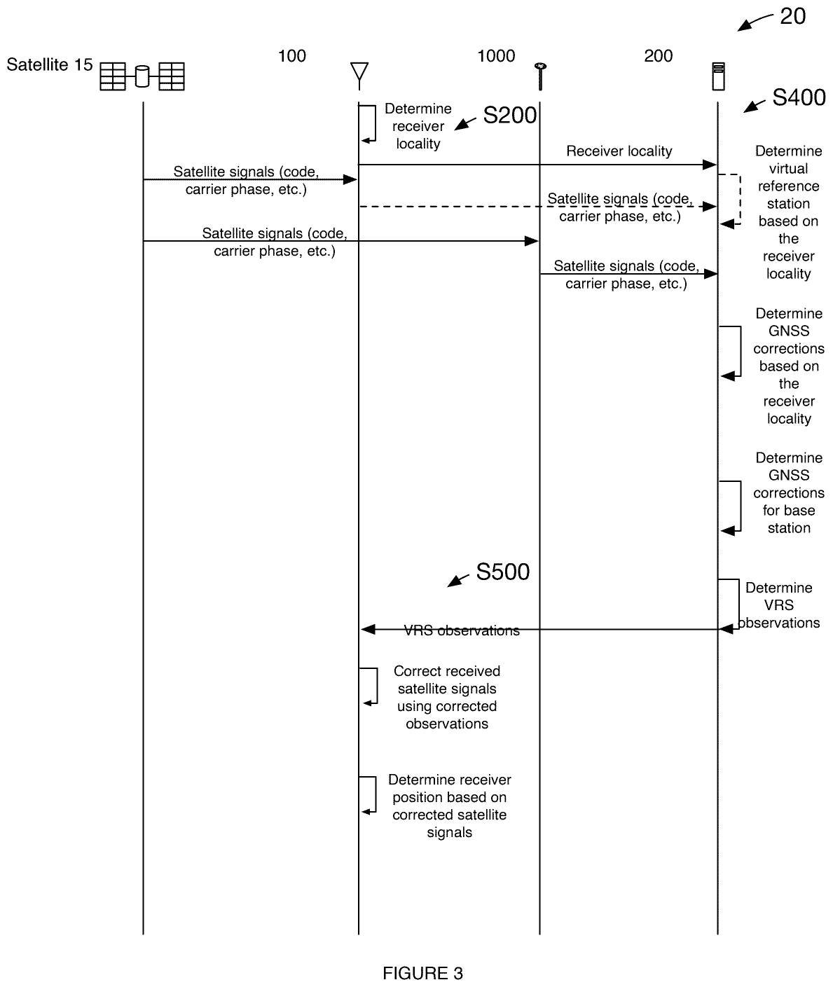

In an illustrative example, as shown for instance in FIG. 3, a method can include: determining a receiver locality; at a GNSS receiver, receiving satellite signals; at a base station, receiving a second set of satellite signals; optionally, determining a virtual reference station location based on the receiver locality; determining SSR corrections at the VRS location; determining SSR corrections for the base station; combining (e.g., computing a difference between) the VRS SSR corrections, the base station SSR corrections and the base station satellite signals to determined corrected observations (e.g., synthetic observations, VRS observations, etc.); correcting the GNSS receiver satellite signals using the VRS observations; and determining the GNSS receiver PVT solutions based on the corrected satellite signals.

The methods of the preferred embodiment and variations thereof can be embodied and/or implemented at least in part as a machine configured to receive a computer-readable medium storing computer-readable instructions. The instructions are preferably executed by computer-executable components integrated with a system for GNSS PVT generation. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A system comprising:
a mobile GNSS receiver configured to:
determine a locality of the mobile GNSS receiver;
transmit the locality to a remote computing server; and
determine a positioning solution associated with the mobile GNSS receiver based on a set of GNSS receiver satellite observations; and
the remote computing server, wherein the remote computing server is configured to:
receive the locality of the mobile GNSS receiver;
generate a virtual reference station at a location that depends on the locality of the mobile GNSS receiver;
receive a set of reference station satellite observations associated with a reference station;
determine a first GNSS correction associated with the location of the virtual reference station;
determine a second GNSS correction associated with a location of the reference station;
determine an observation space representation correction by combining the set of reference station satellite observations, the first GNSS correction, and the second GNSS correction; and
transmitting the observation space representation corrections to the mobile GNSS receiver;
wherein the mobile GNSS receiver is configured to use the observation space representation corrections to determine the positioning solution.

2. The system of claim 1, wherein the remote computing system is further configured to:
receiving a second set of reference station satellite observations associated with a second reference station located at a second reference station location;
determine a third GNSS correction for the second reference station location; and
wherein determining the observation space representation correction further comprises combining the set of reference station satellite observations, the first GNSS correction, the second GNSS correction, the second set of reference station satellite observations, and the third GNSS correction.

3. The system of claim 1, wherein the first GNSS correction and the second GNSS correction comprise state space representation corrections.

4. The system of claim 1, wherein the location of the virtual reference station is approximately the same as the locality of the GNSS receiver.

5. The system of claim 1, wherein the remote computing system is further configured to update the virtual reference station location to a second virtual reference station location when a distance between the virtual reference station location and the position of the mobile receiver exceeds a threshold distance.

6. The system of claim 5, wherein the threshold distance is 10 kilometers.

7. The system of claim 5, wherein the second virtual reference station location comprises the position of the mobile receiver when the distance exceeds the threshold distance.

8. The system of claim 1, wherein determining the position of the mobile GNSS receiver comprises:
determining a set of carrier phase ambiguity hypothesis for the second set of corrected satellite observations; and
selecting a carrier phase ambiguity of the set of carrier phase ambiguity hypotheses based on results of a hypothesis test comparing carrier phase ambiguities of the set of carrier phase ambiguity hypotheses.

9. The system of claim 8, wherein the set of carrier phase ambiguity hypotheses comprises integer-valued carrier phase ambiguity hypotheses.

10. The system of claim 1, wherein the remote computing system is configured to determine the first GNSS correction or the second GNSS correction using a Gaussian process.

11. The system of claim 1, wherein combining the set of reference station satellite observations, the first GNSS correction, and the second GNSS correction comprises:
determining a difference between the first GNSS correction and the second GNSS correction; and
adding the difference between the first GNSS correction and the second GNSS correction and the set of reference station satellite observations.

12. The system of claim 1, wherein the locality is an initial position of the mobile GNSS receiver.
